(19) United States
(12) Patent Application Publication
(10) Pub. No.: US 2007/0173581 A1
(43) Pub. Date: Jul. 26, 2007

(54) High-transparency laser-markable and laser-weldable plastic materials

(75) Inventors: Harald Hager, Freigericht (DE); Thomas Hasskerl, Kronberg (DE); Roland Wursche, Dulmen (DE); Gunther Ittmann, Gross-Umstadt (DE); Hans-Gunther Lohkamper, Haltern (DE); Klaus-Dieter Schubel, Recklinghausen (DE)

Correspondence Address: FITCH, EVEN, TABIN & FLANNERY, P. O. BOX 18415, WASHINGTON, DC, 20036, US

(73) Assignee: Degussa AG, Dusseldorf (DE)

(21) Appl. No.: 10/591,289

(22) PCT Filed: Feb. 18, 2005
(86) PCT No.: PCT/EP05/01689

§ 371 Date: Aug. 31, 2006

(30) Foreign Application Priority Data
Mar. 4, 2004 (DE) 10 2004 010 504.9

(51) Int. Cl. C08K 3/22

(52) U.S. Cl. 524/430

(57) ABSTRACT

The present invention relates to high-transparency plastic materials which are laser-markable and/or laser-weldable due to a content of nanoscale laser-sensitive metal oxides. These plastic materials, which may be provided as molded bodies, semifinished products, molding compounds, or lacquers, particularly contain metal oxides having particle sizes from 5 to 100 nm and a content of 0.0001 to 0.1 weight-percent. Typical metal oxides are nanoscale indium-tin oxide or antimony-tin oxide. These materials may be used in particular for producing laser-markable production products.

The present invention relates to high-transparency plastic materials which are laser-markable and/or laser-weldable due to a content of nanoscale laser-sensitive metal oxides, a method for producing plastic materials of this type, and their use.

The identification of plastic through laser marking and also the welding of plastics using laser energy are known per se. Both are caused by absorption of the laser energy in the plastic material either directly through interaction with the polymer or indirectly using a laser-sensitive agent added to the plastic material. The laser-sensitive agent may be an organic coloring or a pigment, which causes a locally visible discoloration of the plastic through absorption of the laser energy. It may be a compound which is converted from an invisible, colorless form into a visible form upon irradiation with laser light. In laser welding, the plastic material is so strongly heated in the join area through absorption of the laser energy that the material melts and both parts weld to one another.

The identification of production products is becoming increasingly more important in nearly all industrial branches. Thus, for example, production dates, batch numbers, expiration dates, product identifications, barcodes, company logos, etc. must be applied. Compared to conventional identification technologies such as printing, embossing, stamping, and labeling, laser marking is significantly more rapid, since it operates without contact, more precise, and may be applied even to nonplanar surfaces without further measures. Since the laser markings are produced under the surface in the material, they are permanent, stable, and significantly more resistant to removal, alteration, or even forging. Contact with other media, for example in liquid containers and closures, is also noncritical for this reason—with the obvious condition that the plastic matrix is resistant. Security and permanence of product identifications, as well as freedom from contamination, are extraordinarily important in packages of pharmaceuticals, foods, and beverages, for example.

In practice, the principle of composite formation between join partners in laser welding is based on a join partner facing toward the laser source having sufficient transparency for the light of the laser source, which has a specific wavelength, so that the radiation reaches the join partner lying underneath, where it is absorbed. Because of this absorption, heat is released, so that in the contact region of the join partners, not only the absorbing material, but rather also the transparent material melt locally and partially mix, through which a composite is produced after cooling. Both parts are welded to one another in this way as a result.

The laser markability or laser weldability is a function of the nature of the plastic materials and/or the polymers which they are based on, of the nature and content of any laser-sensitive additives, and of the wavelength and radiation power of the laser used. In addition to CO₂ and Excimer lasers, Nd:YAG lasers (neodymium-doped yttrium-aluminum-garnet lasers), having the characteristic wavelengths 1064 nm and 532 nm, are increasingly used in this technology, and more recently even diode lasers. In laser marking, good recognizability—as dark as possible in front of a light background—and high contrast are desired.

Laser-markable or laser-weldable plastic materials, which contain laser-sensitive additives in the form of colorings and/or pigments, generally have a more or less pronounced coloration and/or intransparency. In the case of laser welding, the molding compound to be made laser-absorbent is most frequently thus equipped by introducing carbon black.

For example, laser-markable plastic materials which contain pigments having a conductive layer made of doped tin oxide are described in EP 0 797 511 B1. These pigments, which are contained in the material in concentrations of 0.1 to 4 weight-percent, are based on flaked transparent or semitransparent substrates, particularly layered silicates such as mica. Transparent thermoplastics having pigments of this type display a metallic glimmer, however, which may be completely covered by adding covering pigments. Therefore, high-transparency laser-markable plastic materials may not be produced using pigments of this type.

Laser-markable products which contain antimony trioxide having particle sizes over 0.5 μm as the laser marking pigment are described in WO 01/00719. Dark markings on a light background and good contrast are obtained. However, the products are no longer transparent because of the particle size of the pigment.

Only a few polymer systems are laser-markable or laser-weldable per se and without further laser-sensitive additives. Polymers having ring-shaped or aromatic structures are predominantly used for this purpose, which tend to carbonize easily under the effect of laser radiation. Polymer materials of this type are not weather-stable because of their composition. The contrast of the inscriptions is poor and is only improved by adding laser-sensitive particles or colorings. These polymer materials are also not weldable because of a lack of laser transparency.

Laser-markable polymer compositions made of a polymethyl acrylate having an acrylate comonomer and a second polymer made of styrene and maleic acid anhydride, which may possibly contain still further additives, are described in WO 98/28365. Because of the content of styrene and maleic acid anhydride, no additional laser-sensitive pigments are required. The molded parts have a haze of approximately 5-10%. Plastic molded bodies having a haze of approximately 5-10% do not fulfill the current requirements, however. A haze below 1%, or at least below 2%, is needed for high-transparency requirements.

A method for laser-welding of plastic molded parts, the laser beam being conducted through a laser-transparent molded part I and causing heating in a laser-absorbent molded part II, through which the welding occurs, is described in DE 10054859 A1. The molded parts contain laser-transparent and laser-absorbent colorings and pigments, particularly carbon black, which are tailored to one another in such a way that a homogeneous color impression arises. The material is not naturally transparent.

High-transparency laser-markable and laser-weldable plastic materials, particularly those which are additionally weather-resistant, are not known from the prior art.

The present invention is therefore based on the object of providing high-transparency laser-markable and laser-weldable plastic materials. In particular, laser-sensitive additives for plastic materials are to be found, using which these materials may be made laser-markable and/or laser-weldable without impairing the transparency of the material.

Surprisingly, it has been found that high-transparency plastic materials may be made laser-markable and/or laser-weldable through a content of nanoscale laser-sensitive metal oxides without impairing the transparency.

The object of the present invention is therefore high-transparency plastic materials which are characterized in that they are laser-markable and/or laser-weldable due to a content of nanoscale laser-sensitive metal oxides.

The object of the present invention is also the use of nanoscale laser-sensitive metal oxides for producing high-transparency laser-markable and/or laser-weldable plastic materials.

In addition, the object of the present invention is a method for producing high-transparency laser-markable and/or laser-weldable plastic materials with the aid of nanoscale laser-sensitive metal oxides, the metal oxides being incorporated into the plastic matrix with high shear.

The present invention is based on the recognition that the laser marking pigments known from the related art are not suitable for high-transparency systems in regard to their particle size and their morphology, since they typically significantly exceed the critical size of a fourth of the wavelength of visible light of approximately 80 nm. Laser-sensitive pigments having primary particles below 80 nm particle size are known, but these are not provided in the form of isolated primary particles or small aggregates, but rather, as in the case of carbon black, for example, are only available as highly aggregated, partially agglomerated particles having a significantly larger particle diameter. The known laser marking pigments therefore lead to significant scattering of the light and therefore to clouding of the plastic material.

According to the present invention, nanoscale laser-sensitive metal oxides are added to the plastic materials, particularly those which have a high transparency per se, in order to make them laser-markable and/or laser-weldable.

High-transparency plastic materials are to be understood as those which have a transmission greater than 85% and particularly greater than 90% and a haze less than 3%, preferably less than 2%, and particularly less than 1% at a material thickness of 2 mm. Transmission and haze are determined in accordance with ASTM D 1003.

Laser-sensitive metal oxides are to be understood as all inorganic-metallic oxides such as metal oxides, mixed metal oxides, and complex oxides which absorbed in the characteristic wavelength range of the laser to be used and are thus capable of producing a locally visible alteration in the plastic matrix in which they are embedded.

Nanoscale is to be understood in that the largest dimension of the discrete particles of these laser-sensitive metal oxides is smaller than 1 μm, i.e., in the nanometer range. In this case, this size definition relates to all possible particle morphologies such as primary particles and possible aggregates and agglomerates.

The particle size of the laser-sensitive metal oxides is preferably 1 to 500 nm and particularly 5 to 100 nm. If the particle size is selected below 100 nm, the metal oxide particles are no longer visible per se and do not impair the transparency of the plastic matrix.

In the plastic material, the content of laser-sensitive metal oxides is expediently 0.0001 to 0.1 weight-percent, preferably 0.001 to 0.01 weight-percent, in relation to the plastic material. A sufficient laser markability or laser weldability of the plastic matrix is typically caused in this concentration range for all plastic materials coming into consideration.

If the particle size and concentration are selected suitably in the range specified, even with high-transparency matrix materials, impairment of the intrinsic transparency is prevented. It is thus expedient to select the lower concentration range for metal oxides having particle sizes above 100 nm, while higher concentrations may also be selected for particle sizes below 100 nm.

Doped indium oxide, doped tin oxide, and doped antimony oxide preferably come into consideration as the nanoscale laser-sensitive metal oxides for manufacturing high-transparency laser-markable and/or laser-weldable plastic materials.

Especially suitable metal oxides are indium-tin oxide (ITO) or antimony-tin oxide (ATO) as well as doped indium-tin and/or antimony-tin oxide. Indium-tin oxide is especially preferred and in turn the “blue” indium-tin oxide thereof obtainable through a partial reduction process. The non-reduced “yellow” indium-tin oxide may cause a visually perceivable slightly yellowish tint of the plastic material at higher concentrations and/or particle sizes in the upper range, while the “blue” indium-tin oxide does not lead to any perceivable color change.

The laser-sensitive metal oxides to be used according to the present invention are known per se and are commercially available even in nanoscale form, i.e., as discrete particles having sizes below 1 μm and particularly in the size range preferred here, typically in the form of dispersions.

The laser-sensitive metal oxides are typically provided as agglomerated particles, for example, as agglomerates whose particle size may be from 1 μm to multiple millimeters. These may be incorporated into the plastic matrix with strong shear using the method according to the present invention, through which the agglomerates are broken down into the nanoscale primary particles.

The determination of the degree of agglomeration is performed as defined in DIN 53206 (of August 1972).

Nanoscale metal oxides in particular, may be produced, for example, through pyrolytic methods. Such methods are described, for example, in EP 1 142 830 A, EP 1 270 511 A, or DE 103 11 645. Furthermore, nanoscale metal oxides may be manufactured through precipitation methods, as described in DE 100 22 037, for example.

The nanoscale laser-sensitive metal oxides may be incorporated into practically all plastic systems in order to provide them with laser markability or laser weldability. Plastic materials in which the plastic matrix is based on poly(meth)acrylate, polyamide, polyurethane, polyolefins, styrene polymers and styrene copolymers, polycarbonate, silicones, polyimides, polysulfone, polyethersulfone, polyketones, polyetherketones, PEEK, polyphenylene sulfide, polyester (such as PET, PEN, PBT), polyethylene oxide, polyurethane, polyolefins, or polymers containing fluorine (such as PVDF, EFEP, PTFE) are typical. Incorporation into blends, which contain the above-mentioned plastics as components, or into polymers derived from these classes, which were changed through subsequent reactions, is also possible. These materials are known and commercially available in manifold forms. The advantage according to the present invention of the nanoscale metal oxides particularly comes to bear in high-transparency plastic systems such as polycarbonates, transparent polyamides (such as Grilamid® TR55, TR90, Trogamid® T5000, CX7323), polyethylene terephthalate, polysulfone, polyethersulfone, cycloolefin copolymers (Topas®, Zeonex®), polymethyl methacrylate, and their copolymers, since they do not influence the transparency of the material. Furthermore, transparent polystyrene and polypropylene are to be cited, as well as all partially crystalline plastics which may be processed into transparent films or molded bodies by using nucleation agents or special processing conditions.

The transparent polyamides according to the present invention are generally manufactured from the following components: branched and unbranched aliphatic (6 through 14 C atoms), alkyl-substituted or unsubstituted cycloaliphatic (14 through 22 C atoms), araliphatic diamines (C14-C22), and aliphatic and cycloaliphatic dicarboxylic acids (C6 through C44); the latter may be partially replaced by aromatic dicarboxylic acids. In particular, the transparent polyamides may additionally be composed from monomer components having 6 C atoms, 11 C atoms, and/or 12 C atoms, which are derived from lactams or ω-amino carboxylic acids.

Preferably, but not exclusively, the transparent polyamides according to the present invention are manufactured from the following components: laurin lactam or ω-amino dodecanoic acid, azelaic acid, sebacic acid, dodecanoic diacid, fatty acids (C18-C36; e.g., under the trade name Pripol®), cyclohexane dicarboxylic acids, with partial or complete replacement of these aliphatic acids by isoterephthalic acid, terephthalic acid, naphthalene dicarboxylic acid, tributyl isophthalic acid. Furthermore decane diamine, dodecane diamine, nonane diamine, hexamethylene diamine in unbranched, branched, or substituted forms, as well as representatives from the class of alkyl-substituted/unsubstituted cycloaliphatic diamines bis-(4-aminocyclohexyl)-methane, bis-(3-methyl-4-aminocyclohexyl)-methane, bis-(4-aminocyclohexyl)-propane, bis-(aminocyclohexane), bis-(aminomethyl)-cyclohexane, isophorone diamine or even substituted pentamethylendiamines may be used.

Examples of corresponding transparent polyamides are described, for example, in EP 0 725 100 and EP 0 725 101.

High-transparency plastic systems based on polymethyl methacrylate, bisphenol-A-polycarbonate, polyamide, and cycloolefin copolymers made of norbornene and α-olefins are especially preferred, which may be made laser-markable or laser-weldable with the aid of the nanoscale metal oxides according to the present invention, without impairing the transparency of the material.

The high-transparency laser-markable plastic materials according to the present invention may be provided as molded bodies, semifinished products, molding compounds, or lacquers. The high-transparency laser-weldable plastic materials according to the present invention are typically provided as molded bodies or semifinished products.

The production of the high-transparency laser-markable and/or laser-weldable plastic materials according to the present invention is performed in a way known per se according to technologies and methods current in typical in plastic production and processing. It is possible to introduce the laser-sensitive additives before or during the polymerization or polycondensation in individual reactants or reactant mixtures or also add them during the reaction, specific production methods for the relevant plastics which are known to those skilled in the art being used. In the case of polycondensates such as polyamides, the additives may be incorporated into one of the monomer components, for example. This monomer component may then be subjected to a polycondensation reaction with the remaining reaction partners in a typical way. Furthermore, after formation of macromolecules, the resulting high molecular weight intermediate or final products may be admixed with the laser-sensitive additives, all methods known to those skilled in the art also being able to be used in this case.

Depending on the formulation of the plastic matrix material, fluid, semifluid, and solid formulation components or monomers as well as possibly necessary additives such as polymerization initiators, stabilizers (such as UV absorbers, heat stabilizers), visual brighteners, antistatic agents, softeners, demolding agents, lubricants, dispersing agents, antistatic agents, but also fillers and reinforcing agents or impact resistance modifiers are mixed and homogenized in devices and systems typical for this purpose, such as reactors, stirring vessels, mixers, roller mills, extruders, etc., possibly shaped, and then caused to cure. The nanoscale laser-sensitive metal oxides are introduced into the material at the suitable instant for this purpose and incorporated homogeneously. The incorporation of the nanoscale laser-sensitive metal oxides in the form of a concentrated pre-mixture (masterbatch) with the identical or a compatible plastic material is especially preferred.

It is advantageous if the incorporation of the nanoscale laser-sensitive metal oxides into the plastic matrix is performed with high shear in the plastic matrix. This may be performed through appropriate setting of the mixers, roller mills, and extruders. In this way, any possible agglomeration or aggregation of the nanoscale metal oxide particles into larger units may be effectively prevented; any existing larger particles are broken down. The corresponding technologies and the particular method parameters to be selected are well-known to those skilled in the art.

Plastic molded bodies and semifinished products are obtainable from the monomers and/or pre-polymers through injection molding or extruding from molding compounds or through casting methods.

The polymerization is performed through methods known to those skilled in the art, for example, by adding one or more polymerization initiators and inducing the polymerization through heating or irradiation. For complete conversion of the monomer(s), a tempering step may follow the polymerization.

Laser-markable and laser-weldable lacquer coatings are obtainable through dispersion of nanoscale laser-sensitive oxides in typical lacquer formulations, coating, and drying or hardening of the lacquer layer.

The group of suitable lacquers comprises, for example, powder lacquers, physically drying lacquers, radiation-curable lacquers, single-component or multicomponent reactive lacquers, such as two-component polyurethane lacquers.

After plastic molded parts or lacquer coatings are produced from the plastic materials containing nanoscale laser-sensitive metal oxides, they may be marked or welded through irradiation using laser light.

The laser marking may be performed on a commercially available laser marking device, such as a laser from Baasel, Type StarMark SMM65, having an average laser output of 65 W and a writing speed between 1 and 200 mm/seconds. The molded body to be inscribed is inserted into the device and white to dark-gray writing having sharp contours and good readability on the colorless, transparent substrate is obtained after irradiation. In a special embodiment, the laser beam may also advantageously be focused above the substrate. A larger number of pigment particles are thus excited and intensive, high contrast inscribed images are obtained even at low pigment concentrations. The required energy in the writing speed are a function of the composition and quantity of the laser-sensitive oxide used. The high the oxide content, the lower the required energy in the higher the maximum writing speed of the laser beam. The required settings may be ascertained in the individual case without further measures.

The laser welding may be performed on a commercially available laser marking device, such as a laser from Baasel, Type StarMark SMM65, having an output between 0.1 and 22 amperes and an advance speed between 1 and 100 mm/seconds. When setting the laser energy and advance speed, it is to be ensured that the output is not selected too high and the advance speed is not selected too low, in order to avoid undesired carbonization. At too low an output and too high an advance speed, the welding may be inadequate. The required settings may also be determined in the individual case for this purpose without further measures.

For welding plastic molded bodies or plastic semifinished products, it is necessary for at least one of the parts to be joined to comprise plastic material according to the present invention at least in the surface region, the join surface being irradiated with laser light to which the metal oxide contained in the plastic material is sensitive. The method is expediently performed so that the join part facing toward the laser beam does not absorb the laser energy and the second join part is made of the plastic material according to the present invention, through which the parts are so strongly heated at the phase boundary that both parts are welded to one another. A certain contact pressure is necessary in order to obtain a material bond.

The high-transparency laser-sensitive plastic materials according to the present invention may be used very advantageously for producing laser-markable production products. The identification of production products, produced from these plastic materials, is performed by irradiating them with laser light to which the metal oxide contained in the plastic material is sensitive.

### COMPARATIVE EXAMPLE A

Trogamid® CX 7323, a commercial product of Degussa AG, high performance polymers branch, Mar1, was used as the plastic molding compound. Iriodin® LS800 from Merck KgaA, Darmstadt, was used as the laser-sensitive pigment in a concentration of 0.2 weight-percent.

The light transmission in the visible range was 80% and the haze was 5%.

### COMPARATIVE EXAMPLE B

Plexiglas® 7N, a commercial product of Degussa AG, methacrylates branch, Darmstadt, was compounded and granulated on a 35 extruder, Storck, having a degassing zone at 240° C. Iriodin® LS800 from Merck KgaA, Darmstadt, was used as the laser-sensitive pigment in a concentration of 0.2 weight-percent.

The light transmission in the visible range was 85% and the haze was 4%.

### EXAMPLE 1

Production of a High-Transparency Laser-Sensitive Plastic Molded Body

A plastic molding compound, containing a laser-sensitive nanoscale pigment, was melted in an extruder and injected into an injection mold to form plastic molded bodies in the form of lamina or extruded to form slabs, films, or tubes.

The incorporation of the laser-sensitive pigment into the plastic molding compound was performed with strong shear in order to break down possible agglomerated particles into nanoscale primary particles.

### EMBODIMENT A

Trogamid® CX 7323, a commercial product of Degussa AG, high performance polymers branch, Marl, was used as the plastic molding compound. Nanoscale indium-tin oxide Nano®ITO IT-05 C5000 from Nanogate, was used as the laser-sensitive pigment in a concentration of 0.01 weight-percent. The light transmission in the visible range was 90% and the haze was 1.5%.

### EMBODIMENT B

Plexiglas® 7N, a commercial product of Degussa AG, methacrylates branch, Darmstadt, was used as the plastic molding compound. Nanoscale indium-tin oxide Nano®ITO IT-05 C5000 from Nanogate, was used as the laser-sensitive pigment in a concentration of 0.001 weight-percent. In the case of extrusion, a higher molecular weight molding compound of the type Plexiglas® 7H may also advantageously be used. The light transmission in the visible range was 92% and the haze was <1%.

### EXAMPLE 2

Reduction of a High-Transparency Laser-Sensitive Plastic Molding Compound

### EMBODIMENT A

Trogamid® CX 7323, a commercial product of Degussa AG, high performance polymers branch, Marl, was used as the plastic molding compound and compounded and granulated on a Berstorff ZE 2533 D extruder at 300° C. with nanoscale indium-tin oxide Nano®ITO IT-05 C5000 from Nanogate as the laser-sensitive pigment in a concentration of 0.01 weight-percent. The light transmission in the visible range was 90% and the haze was 1.5%.

### EMBODIMENT B

Plexiglas® 7N, a commercial product of Degussa AG, methacrylates branch, Darmstadt, was compounded and granulated on a 35 extruder, Storck, having a degassing zone at 240° C. with nanoscale indium-tin oxide Nano®ITO IT-05 C5000 from Nanogate as the laser-sensitive pigment in a concentration of 0.001 weight-percent. The light transmission in the visible range was 92% and the haze was <1%.

### EXAMPLE 3

Production of a High-Transparency Laser-Sensitive Lacquer and a Lacquer Coating

### EMBODIMENT A

A radiation-curable acrylate lacquer made of 40 weight-parts pentaerythrite-tri-acrylate, 60 weight-parts hexane dioldiacrylate, 100 weight-parts nanoscale indium-tin oxide VP AdNano® ITO R50 from Degussa and 200 weight-parts ethanol was dispersed in a glass vessel for 66 hours on the roller bench while adding glass balls of a diameter of 1 mm, admixed with 2 parts photoinitiator Irgacure® 184 after removing the glass balls, and applied to plastic slabs through squeegeeing with a wire doctor blade. The curing was performed after a brief ventilation time through irradiation using a commercially available Fusion F 400 UV dryer at an advance of 1 m/min under inert gas. The light transmission in the visible range is 90% and the haze is <2%.

### EMBODIMENT B

A physically drying lacquer was produced by dispersing 100 weight-parts nanoscale indium-tin oxide VP AdNano® ITO R50 from Degussa, 100 weight-parts polymethacrylate (Degalan® 742), and 200 weight-parts butyl acetate in a glass vessel for 66 hours on the roller bench while adding glass balls of a diameter of 1 mm. The coating was performed by squeegeeing using a 24 μm wire doctor blade and drying the lacquer at room temperature.

The light transmission in the visible range is 90% and the haze is <2%.

### EXAMPLE 4

Performing Laser Marking

(Cast PMMA Having 0.01 Weight-Percent ITO Content)

A high-transparency laser-sensitive plastic slab (dimensions 100 mm*60 mm*2 mm) made of cast PMMA having an ITO content of 0.01 weight-percent was inserted into the Starmark-Lasers SMM65 tool from Baasel-Lasertechnik. It was to be ensured that the slab has at least 10 mm distance to the lower support surface of the tool. The focus of the laser beam was set to the middle of the slab thickness. The parameters of frequency (2250 Hz), lamp current (21.0 A), and writing speed (100 mms⁻¹) were set on the control unit of the laser. After the desired inscription text was input, the laser was started. At the end of the inscription procedure, the plastic slab may be removed from the device.

The contrast was graded at 4.

The contrast was determined using the following qualitative method:
Contrast grade 0: No inscription possible.
Contrast grade 1: Discoloration of the plastic surface was observed without the script being readable.
Contrast grade 2: The inscription is well readable.
Contrast grade 3: The inscription and the inscription text in Arial 18 bold are well readable.
Contrast grade 4: The inscription, the inscription text in Arial 18 bold, and the inscription text in Arial 12 are well readable.

### EXAMPLE 5

Performing Laser Marking

(Cast PMMA Having 0.0001 Weight-Percent ITO Content)

A high-transparency laser-sensitive plastic slab (dimensions 100 mm*60 mm*2 mm) made of cast PMMA having an ITO content of 0.0001 weight-percent was inserted into the Starmark-Lasers SMM65 tool from Baasel-Lasertechnik. It was to be ensured that the slab has at least 10 mm distance to the lower support surface of the tool. The focus of the laser beam was set to 20 mm above the middle of the slab thickness. The parameters of frequency (2250 Hz), lamp current (22.0 A), and writing speed (10 mms⁻¹) were set on the control unit of the laser. After the desired inscription text was input, the laser was started. At the end of the inscription procedure, the plastic slab may be removed from the device.

The contrast was graded at 4.

### EXAMPLE 6

Performing Laser Marking

(Cast PMMA Coated with PMMA Lacquer Containing 0.001 Weight-Percent ITO)

A high-transparency laser-sensitive plastic slab (dimensions 100 mm*60 mm*2 mm) made of cast PMMA coated on both sides with a PMMA lacquer containing 0.001 weight-percent ITO was inserted into the Starmark-Lasers SMM65 tool from Baasel-Lasertechnik. It was to be ensured that the slab has at least 10 mm distance to the lower support surface of the tool. The focus of the laser beam was set to 20 mm above the middle of the slab thickness. The parameters of frequency (2250 Hz), lamp current (21.0 A), and writing speed (15 mms⁻¹) were set on the control unit of the laser. After the desired inscription text was input, the laser was started. At the end of the inscription procedure, the plastic slab may be removed from the device.

The contrast was graded at 4.

### EXAMPLE 7

Performing Laser Marking

(PA12 Having 0.1 Weight-Percent ITO Content)

A high-transparency laser-sensitive standard injection molded plastic slab (dimensions 60 mm*60 mm*2 mm) made of PA12 having an ITO content of 0.1 weight-percent was inserted into the Starmark-Lasers SMM65 tool from Baasel-Lasertechnik. It was to be ensured that the slab had at least 10 mm distance to the lower support surface of the tool. The focus of the laser beam was set to the middle of the slab thickness. The parameters of frequency (2250 Hz), lamp current (20.0 A), and writing speed (50 mms⁻¹) were set on the control unit of the laser. After the desired inscription text was input, the laser was started. At the end of the inscription procedure, the plastic slab may be removed from the device.

The contrast was graded at 4.

### EXAMPLE 8

Performing Laser Marking

(PA12 Having 0.01 Weight-Percent ITO Content)

A high-transparency laser-sensitive standard injection molded plastic slab (dimensions 60 mm*60 mm*2 mm) made of PA12 having an ITO content of 0.01 weight-percent was inserted into the Starmark-Lasers SMM65 tool from Baasel-Lasertechnik. It was to be ensured that the slab had at least 10 mm distance to the lower support surface of the tool. The focus of the laser beam was set to the middle of the slab thickness. The parameters of frequency (2250 Hz), lamp current (20.0 A), and writing speed (50 mms⁻¹) were set on the control unit of the laser. After the desired inscription text was input, the laser was started. At the end of the inscription procedure, the plastic slab may be removed from the device.

The contrast was graded at 4.

### EXAMPLE 9

Performing Laser Welding

(Cast PMMA Having 0.01 Weight-Percent ITO Content)

A high-transparency laser-sensitive plastic slab (dimensions 60 mm*60 mm*2 mm) made of cast PMMA having an ITO content of 0.01 weight-percent was brought into contact with a second plastic slab made of undoped cast PMMA, using the faces to be welded. The slabs were inserted in the welding support of the Starmark laser SMM65 from Baasel-Lasertechnik in such a way that the undoped slab laid on top, i.e., was first penetrated by the laser beam. The focus of the laser beam was set to the contact face of the two slabs. The parameters frequency (2250 Hz), lamp current (22.0 A), and advance speed (30 mms⁻¹) were set on the control unit of the laser. After the size of the area to be welded was input (22*4 mm²), the laser was started. At the end of the welding procedure, the welded plastic slabs could be removed from the device.

Adhesion values having the grade 4 were achieved in the hand test.

The adhesion was evaluated as follows:

| | |
|---|---|
| 0 | no adhesion. |
| 1 | slight adhesion. |
| 2 | some adhesion; to be separated with little |
| | trouble. |
| 3 | good adhesion; only to be separated with great |
| | trouble and possibly with the aid of tools. |
| 4 | inseparable adhesion; separation only through |
| | cohesion fracture. |

### EXAMPLE 10

Performing Laser Welding

(PA12 Having 0.01 Weight-Percent ITO Content)

A high-transparency laser-sensitive standard injection molded plastic slab (dimensions 60 mm*60 mm*2 mm) made of PA12 having an ITO content of 0.01 weight-percent was brought into contact with a second standard injection molded plastic slab (dimensions 60 mm*60 mm*2 mm) made of undoped PA 12, using the faces to be welded. The slabs were inserted in the welding support of the Starmark laser SMM65 from Baasel-Lasertechnik in such a way that the undoped slab laid on top, i.e., was first penetrated by the laser beam. The focus of the laser beam was set to the contact face of the two slabs. The parameters frequency (2250 Hz), lamp current (22.0 A), and advance speed (10 mms⁻¹) were set on the control unit of the laser. After the size of the area to be welded was input (22*4 mm²), the laser was started. At the end of the welding procedure, the welded plastic slabs could be removed from the device.

Adhesion values having the grade 4 were achieved in the hand test.

1-18. (canceled)

19. A high-transparency plastic material comprising:
a) a plastic matrix; and
b) a nanoscale laser-sensitive metal oxide within said plastic matrix;
wherein said plastic material is laser-markable or laser-weldable.

20. The plastic material of claim 19, wherein said metal oxide has a particle size of 1 to 500 nm.

21. The plastic material of claim 20, wherein said particle size is 5 to 100 nm.

22. The plastic material of claim 19, wherein said metal oxide comprises 0.0001 to 0.1 weight-percent of said plastic material.

23. The plastic material of claim 22, wherein said metal oxide comprises 0.001 to 0.01 weight-percent of said plastic material.

24. The plastic material of claim 19, wherein said metal oxide is selected from the group consisting of: doped indium oxide; doped tin oxide; and doped antimony oxide.

25. The plastic material of claim 24, wherein said metal oxide is indium-tin oxide or antimony-tin oxide.

26. The plastic material of claim 25, wherein said metal oxide is blue indium-tin oxide.

27. The plastic material of claim 19, wherein said plastic matrix comprises one or more materials selected from the group consisting of: poly(meth)acrylate; polyamide; polyurethane; polyolefins; styrene polymers and styrene copolymers; polycarbonate; silicones; polyimides; polysulfone; polyethersulfone; polyketones; polyetherketones; polyphenylensulfide; polyester; polyethylenoxide; polyurethane; polyolefins; and fluorine-containing polymers.

28. The plastic material of claim 19, wherein said plastic matrix comprises polymethyl methacrylate.

29. The plastic material of claim 19, wherein said plastic matrix comprises bisphenol-A-polycarbonate.

30. The plastic material of claim 19, wherein said plastic matrix comprises polyamide.

31. The plastic material of claim 19, said wherein said metal oxide:
a) has a particle size of 1 to 500 nm; and
b) comprises 0.0001 to 0.1 weight-percent of said plastic material.

32. The plastic material of claim 31, wherein said metal oxide is selected from the group consisting of: doped indium oxide; doped tin oxide; and doped antimony oxide.

33. The plastic material of claim 32, wherein said plastic matrix comprises one or more materials selected from the group consisting of: poly(meth)acrylate; polyamide; polyurethane; polyolefins; styrene polymers and styrene copolymers; polycarbonate; silicones; polyimides; polysulfone; polyethersulfone; polyketones; polyetherketones; polyphenylensulfide; polyester; polyethylenoxide; polyurethane; polyolefins; and fluorine-containing polymers.

34. The plastic material of claim 19, wherein said plastic material is in the form of a molded body, semifinished product, molding compounds, or lacquers.

35. A method for producing a high-transparency laser-markable and/or laser-weldable plastic material, comprising mixing nanoscale laser-sensitive metal oxides with a plastic matrix under conditions of high shear.

36. The method of claim 35, wherein:
a) said metal oxide:
i) has a particle size of 1 to 500 nm;
ii) comprises 0.0001 to 0.1 weight-percent of said plastic material;
iii) is selected from the group consisting of: doped indium oxide; doped tin oxide; and doped antimony oxide; and
b) said plastic matrix comprises one or more materials selected from the group consisting of: poly(meth)acrylate; polyamide; polyurethane; polyolefins; styrene polymers and styrene copolymers; polycarbonate; silicones; polyimides; polysulfone; polyethersulfone; polyketones; polyetherketones; polyphenylensulfide; polyester; polyethylenoxide; polyurethane; polyolefins; and fluorine-containing polymers.

37. The method of claim 35, wherein said nanoscale laser-sensitive metal oxides are in the form of a concentrated pre-mixture with the plastic material.

38. A method for welding plastic molded bodies or plastic semifinished products, wherein at least one of the parts to be joined comprises a plastic material according to claim 1 at least in the surface area, said method comprising irradiating a join face of said plastic molded bodies or plastic semifinished products with laser light to which the metal oxide contained in said plastic material is sensitive.
